(19) United States
(12) Patent Application Publication
(10) Pub. No.: US 2024/0043058 A1
(43) Pub. Date: Feb. 8, 2024

(54) PROTECTIVE SHIELD FOR AN INFANT CARRIER OR CARRIAGE OR CAR SEAT OR STROLLER

(71) Applicants: Jaqueline Reyes, Baldwin, NY (US); Joanna P. Zayas, Glendale, NY (US)

(72) Inventors: Jaqueline Reyes, Baldwin, NY (US); Joanna P. Zayas, Glendale, NY (US)

(21) Appl. No.: 17/817,057

(22) Filed: Aug. 3, 2022

(51) Int. Cl. B62B 9/14; B60N 2/26

(52) U.S. Cl. CPC B62B 9/142; B60N 2/26

(57) ABSTRACT

A protective shield for an infant carrier or carriage or car seats or stroller is generally disclosed herein. The protective shield includes a hingedly movable frame, a see-through cover, and a mesh screen. The see-through cover and the mesh screen are coupled to the frame such that a child, while in the car seat or child carrier, is protected from viruses and other pathogens contained in touch and droplet transmission.

### BACKGROUND OF THE INVENTION

The present invention relates to infant carrier or carriage or car seats or stroller and, more particularly, to A plastic/mesh protective baby shield that attaches to an infant carrier or carriage or car seats or stroller acting as a barrier between a baby and the environment.

As of the filing date of the present disclosure, individuals must wear masks due to a global pandemic (specifically, the COVID-19 pandemic). However, there is no protection currently against infectious agents for infants and children under two years of age who are carried around in child car seats and other infant carriers. Rather, they are exposed to any viruses that are airborne and in their proximity.

While other covers exist, such as a protective rain cover, they are not intended to be used for an extended amount of time or when indoors. Rain covers do not allow for easily accessing child for basic needs, feeding, wiping, and the like. Further, baby rain covers are not made with the intention to provide added ventilation needed when used indoors. In terms of protection from viruses and other airborne pathogens, masks are not a feasible option for young children, as they do not understand that the mask is intended to protect and should not be removed.

As can be seen, there is a need for a protective shield designed for infant carrier or carriage or car seats or stroller that can be used for long periods of time and protects against viruses and other pathogens/germs. The protective shield advantageously serves as a barrier against germs that can be passed on through touch and droplet transmission (e.g., coughing, sneezing, or talking), while providing adequate ventilation so that it may be used for extended periods of time and in various settings (e.g., indoors and outdoors).

### SUMMARY OF THE INVENTION

In one aspect of the present invention, a protective shield for a infant carrier or carriage or car seats or stroller is disclosed, with the protective shield including: a frame movable between an extended position and a retracted position and being dimensioned to sit on the infant carrier or carriage or car seats or stroller, the frame including: a first hinge and a second hinge; an upper flexible bar and a lower flexible bar, with each being hingedly coupled to the first hinge and the second hinge; and an upper rod and a lower rod, with each being hingedly coupled to the first hinge and the second hinge, the upper rod and the lower rod being disposed between the upper flexible bar and the lower flexible bar when the frame is extended; a see-through cover coupled to the upper flexible bar, the upper rod, and the lower rod; and a mesh screen coupled to the lower rod and the lower flexible bar.

In another aspect of the present invention, a system is disclosed that includes: infant carrier or carriage or car seats or stroller; and a protective shield including: a frame movable between an extended position and a retracted position and being dimensioned to sit on the car seat or the child carrier, the frame including: a first hinge and a second hinge; an upper flexible bar and a lower flexible bar, with each being hingedly coupled to the first hinge and the second hinge; and an upper rod and a lower rod, with each being hingedly coupled to the first hinge and the second hinge, the upper rod and the lower rod being disposed between the upper flexible bar and the lower flexible bar when the frame is extended; a see-through cover coupled to the upper flexible bar, the upper rod, and the lower rod; and a mesh screen coupled to the lower rod and the lower flexible bar.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of an embodiment of the present invention, shown in-use;

FIG. 2 is a perspective view of the embodiment of the present invention;

FIG. 3 is an exploded view of the embodiment of the present invention;

FIG. 4 is a section view of the embodiment of the present invention, taken along line 4-4 from FIG. 2;

FIG. 5 is a perspective view of the embodiment of the present invention, shown in a collapsed position; and

FIG. 6 is a perspective view of the embodiment of the present invention, shown in-use in the collapsed position.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, one embodiment of the present invention is a protective shield for a infant carrier or carriage or car seats or stroller that includes a hingedly movable frame, a see-through cover, and a mesh screen.

In accordance with certain aspects of the present invention, the protective shield creates a barrier between a baby or young child and other individuals and environments, such as when in public spaces. The protective shield prevents individuals from being able to touch the child. The shield may be at least partially formed from a solid, transparent material (such as a plastic) serving as protection for the child when in close contact with an individual who sneezes, coughs, or spits (or otherwise projects potential pathogens from their mouth) when talking, thus preventing droplets and other airborne germs from directly falling onto the child.

Prior to the present invention, there was no product available to protect infants and other young children (e.g., under the age of two) when out in public. As discussed above, the closest prior art in this field includes rain covers for car seats, which generally consist of a plastic material that is permanently affixed in place and is only used to shield the child when outdoors from rain. In comparison, the retractable design of the present invention allows a parent, or other caretaker, easy access to child when needed and nearly instantaneous protection from unwanted contact by easy and fast extension. Further, embodiments of the present invention incorporate strategically placed mesh fabric that allows for easy air ventilation, making it safe for extended usage.

Referring now to FIG. 2, an infant or child protective shield is generally shown. The shield includes two flat flexible bars 10 (formed from, for example, plastic) and two rods 12 (formed from, for example, metal) that are connected via a pair of hinges 12 to define a frame of the shield. The rods 12 being formed from a higher strength material give more support to the overall shield while the flexible bars make the shield more flexible and lightweight. The flexible bars 10 and rods 12 are bent such that opposite ends of each connect to a respective hinge 22. A pair of elastic bands 14 are coupled to the flexible bars 10, with one end of each band 14 being permanently connected one of the flexible bars 10 (this bar 10 also herein referred to as the “upper” bar), and the other end of each band 14 being detachably coupled to connectors 16 provided on the other flexible bar 10 (this bar 10 also herein referred to as the “lower” bar). The connectors 16 may be, but are not limited to, snap connectors, and those with skill in the art will appreciate that various connector types may be utilized.

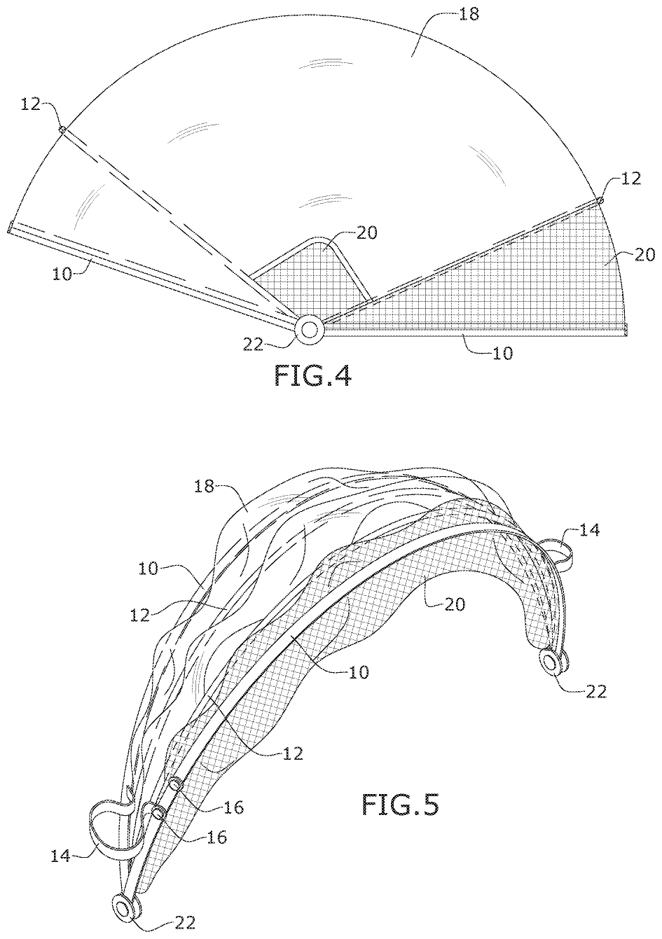

As shown in FIG. 4, an impermeable see-through cover 18 is further provided as part of the protective shield and may be embodied as translucent or transparent in opacity. The cover 18 may be formed, for example and without limitation, from vinyl plastic. The cover 18 is coupled, at a first end, to the upper bar 10. It then extends through, or is otherwise coupled with, the upper rod 12 (the rod 12 shown on the left side of FIG. 4) and terminates at the lower rod 12 (the rod 12 shown on the right side of FIG. 4). A permeable mesh screen 20 is further provided as part of the shield to provide air ventilation when in use. The mesh screen 20, at a first end thereof, is threaded or otherwise coupled with the lower bar 10 and, at a second end thereof, coupled to the lower rod 12. Mesh inserts 20A are positioned proximal the hinges 22 and coupled within cutouts formed in the see-through cover 18 (e.g., first and second cutouts proximal the hinges 22). As these inserts 20A are positioned closer to the infant, in use, they provide for better ventilation while being offset such that droplets cannot penetrate the shield.

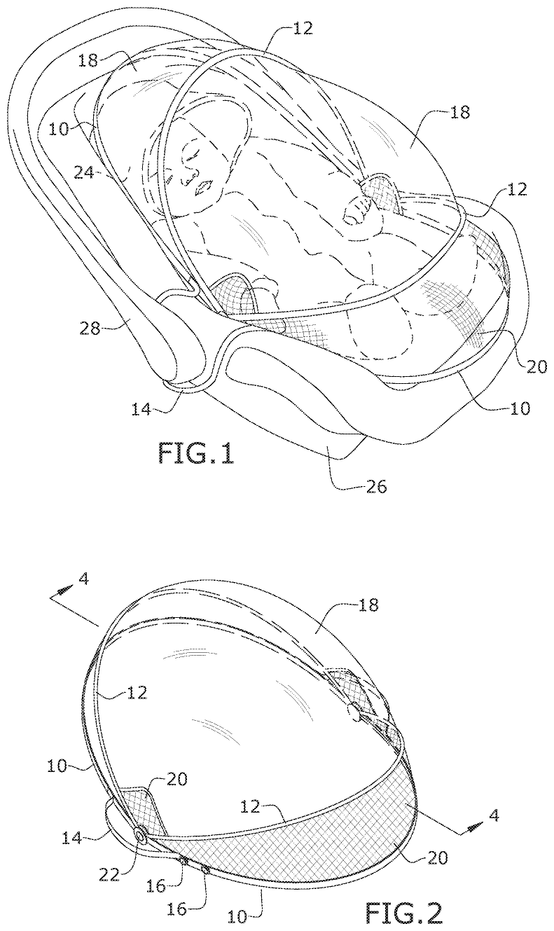

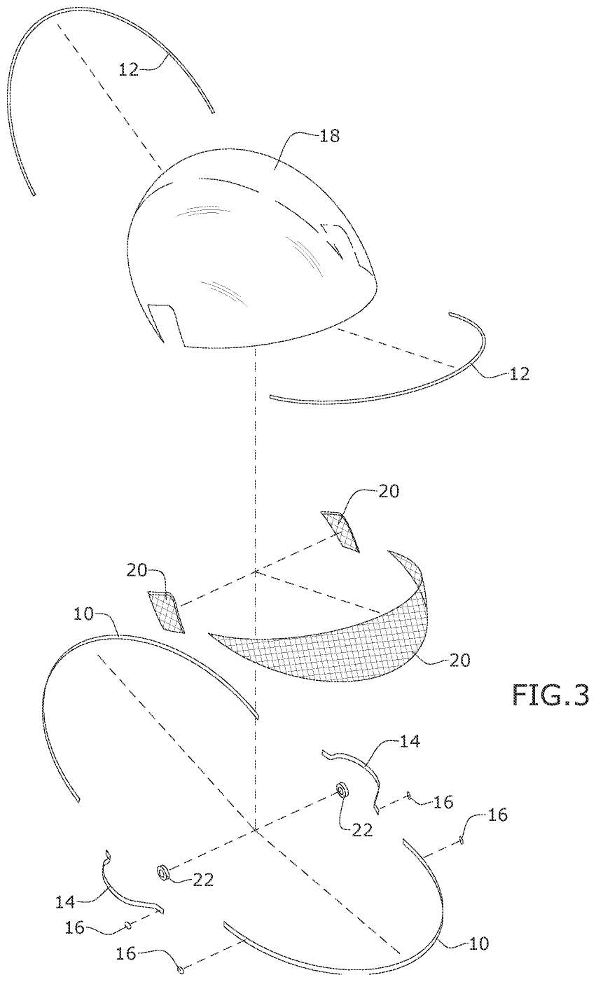

To install and use, and as shown in FIG. 1, the shield is positioned in a car seat 26, or another child carrier i.e infant carrier or carriage or stroller. The elastic bands 14 may be looped around handle arms 28 of the infant carrier or carriage or car seats or stroller 26, or other appropriate structure, to maintain the protective shield in place over a baby 24 or child. The upper bar 10 may be slid under the infant carrier or carriage or car seats or stroller 26 sun canopy and the lower bar 10 extended/pulled to a bottom portion of the infant carrier or carriage or car seats or stroller 26. The protective shield may be sized for various size infant carrier or carriage or car seats or stroller 26 or provided in a standard size that accommodates most infant carrier or carriage or car seats or stroller 26 or child carriers. The protective shield forms a sealed bubble-like structure over the child, thus protecting them from droplet or touch transmission of viruses and other pathogens.

Because the impermeable see-through cover 18 is provided at an upper portion of the protective shield, individuals (like caretakers) are able to see through the shield, and the child 24 is able to interact with others in the room or space. While the cover 18 permits visibility therethrough, direct exposure to droplets and other particulates (originating from, for example, sneezing, coughing, spitting or talking) is prevented.

The mesh screen 20 and mesh inserts 20A are positioned such that adequate ventilation will be permitted within the bubble, while being located in regions that droplets and other particulates cannot readily pass through. When installing, a user should ensure that this region is free of other materials, such as clothing, to allow air to freely flow therethrough. Even if droplets or particulates were to pass through this mesh 20, 20A, the mesh is advantageously located away from where the child's head would sit, providing significantly superior protection from viruses and pathogens than the child would otherwise have (if uncovered).

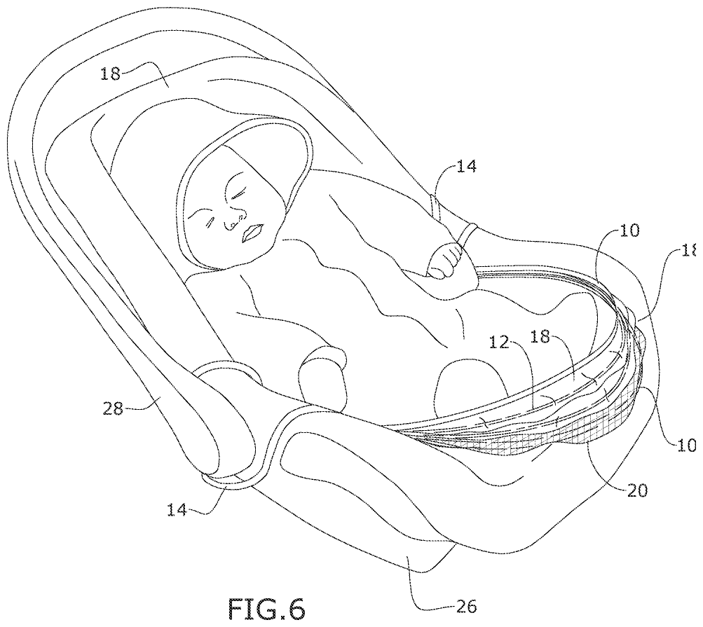

FIGS. 5 and 6 illustrates how the protective shield is collapsible about the hinges 22. When the protective shield is not needed for periods of time (e.g., the child is being transported in a car from a first public location to a second public location), the upper bar 10 can be pulled down to collapse the protective shield proximal the child's feet, while remaining coupled to the car seat 26 via the elastic bands 14.

Various methods of making the present invention may be employed. Flat flexible plastic bars 10 may be connected via hinges 22 may be located on top and bottom sides of the shield and are attached by the clear vinyl plastic cover 18 and mesh fabric 20, 20A, as previously described. Rods 12 may also be connected to the hinges 22 to further define a frame structure for supporting the cover 18 and the mesh 20, 20A. Elastic bands 14 with snap connectors are located along right and left side ends of the bars 10. The bars 10 and rods 20 may be sewn to the clear cover 18 and mesh 20, 20A. The bars 10 and rods 20 may be arcuate in form, creating a half moon/half circle appearance and making it flexible enough to extend to differently sized infant carrier or carriage or car seats or strollers.

While one or more preferred embodiments are disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

What is claimed is:

1. A protective shield for an infant carrier or carriage or car seats or stroller, the protective shield comprising:
a frame movable between an extended position and a retracted position and being dimensioned to sit on the car seat or the child carrier, the frame comprising:
a first hinge and a second hinge;
an upper flexible bar and a lower flexible bar, with each being hingedly coupled to the first hinge and the second hinge; and
an upper rod and a lower rod, with each being hingedly coupled to the first hinge and the second hinge, the upper rod and the lower rod being disposed between the upper flexible bar and the lower flexible bar when the frame is extended;
a see-through cover coupled to the upper flexible bar, the upper rod, and the lower rod; and
a mesh screen coupled to the lower rod and the lower flexible bar.

2. The protective shield of claim 1, wherein the upper flexible bar and the lower flexible bar are formed from a plastic material, and the upper rod and the lower rod are formed from a metal material.

3. The protective shield of claim 1, wherein the see-through cover defines a first cutout proximal the first hinge and a second cutout proximal the second hinge.

4. The protective shield of claim 3, further comprising a first mesh insert positioned in the first cutout and a second mesh insert positioned in the second cutout.

5. The protective shield of claim 1, further comprising a pair of elastic bands, with each elastic band being fixedly coupled to the upper flexible bar and detachably coupled to the lower flexible bar.

6. A system comprising:
an infant carrier or carriage or car seats or stroller car seat or a child;
and
a protective shield comprising:
a frame movable between an extended position and a retracted position and being dimensioned to sit on the car seat or the child carrier, the frame comprising:
a first hinge and a second hinge;
an upper flexible bar and a lower flexible bar, with each being hingedly coupled to the first hinge and the second hinge; and
an upper rod and a lower rod, with each being hingedly coupled to the first hinge and the second hinge, the upper rod and the lower rod being disposed between the upper flexible bar and the lower flexible bar when the frame is extended;
a see-through cover coupled to the upper flexible bar, the upper rod, and the lower rod; and
a mesh screen coupled to the lower rod and the lower flexible bar.

7. The system of claim 6, wherein the upper flexible bar and the lower flexible bar are formed from a plastic material, and the upper rod and the lower rod are formed from a metal material.

8. The system of claim 6, wherein the see-through cover defines a first cutout proximal the first hinge and a second cutout proximal the second hinge.

9. The system of claim 8, wherein the protective shield further comprises a first mesh insert positioned in the first cutout and a second mesh insert positioned in the second cutout.

10. The system of claim 6, wherein the protective shield further comprises a pair of elastic bands, with each elastic band being fixedly coupled to the upper flexible bar and detachably coupled to the lower flexible bar such that each elastic band is loopable around a handle arm of the infant carrier or carriage or car seats or stroller.
